(19) United States
(12) Patent Application Publication
(10) Pub. No.: US 2006/0186738 A1
(43) Pub. Date: Aug. 24, 2006

(54) Method of supplying electric current, method of starting internal combustion engine, power supply apparatus, and vehicle

(76) Inventors: Minoru Noguchi, Higashimatsuyama-shi (JP); Koji Tamenori, Tochigi-ken (JP); Takeshi Taguchi, Saitama-shi (JP); Hiroki Munakata, Tochigi-ken (JP)

Correspondence Address: FISH & RICHARDSON P.C., P.O. BOX 1022, MINNEAPOLIS, MN, 55440-1022, US

(21) Appl. No.: 11/353,671

(22) Filed: Feb. 13, 2006

(30) Foreign Application Priority Data
Feb. 18, 2005 (JP) 2005-42394

(51) Int. Cl. B60L 1/00

(52) U.S. Cl. 307/10.1

(57) ABSTRACT

A power supply apparatus has a lead storage battery and an electric double-layer capacitor which are connected in parallel to each other, and a starter generator for being supplied with electric power discharged from the storage battery and the electric double-layer capacitor and for operating as an electric generator after an engine is started. Electric power generated by the starter generator is supplied to charge the storage battery and the electric double-layer capacitor. An IPU as a connection switching device is connected between the storage battery and the electric double-layer capacitor, and the starter generator. A line length between the electric double-layer capacitor and the starter generator is shorter than a line length between the lead storage battery and the starter generator.

### BACKGROUND OF THE INVENTION

1. Field of the Invention

The present invention relates to a method of supplying an electric current using a storage battery and an electric double-layer capacitor, a method of starting an internal combustion engine, a power supply apparatus, and a vehicle, and more particularly to a method of supplying an electric current, a method of starting an internal combustion engine, a power supply apparatus, and a vehicle which are capable of increasing the service life of a storage battery.

2. Description of the Related Art

Recently, the practice of stopping vehicle engines from idling when vehicles are at rest, i.e., so-called engine idling stop, has been carried out to reduce the emission of exhaust gases from the engines for environmental protection. There have been developed control means for automatically performing such an engine idling stop process.

According to the engine idling stop process, the starter motor is energized each time the engine is restarted after the vehicle has stopped. Therefore, the number of times that a lead storage battery as an electric power source for the starter motor is charged and discharged is increased. Furthermore, the service life of the lead storage battery is shortened as the starter motor is a characteristic load through which a large instantaneous electric current flows.

According to Japanese Laid-Open Patent Publication No. 8-339830, in order to improve the cycle service life characteristics of the lead storage battery, it has been proposed to connect a lead storage battery and a capacitor in parallel to each other and set the electrostatic capacitance of the capacitor to (B−3A)×Δt/96500×1.1 (F) where B represents the maximum load current and A the average load current.

Japanese Laid-Open Patent Publication No. 9-247856, Japanese Laid-Open Patent Publication No. 9-252546, and Japanese Laid-Open Patent Publication No. 10-191576 disclose systems wherein an electric double-layer capacitor having a large electrostatic capacitance is mounted as an electric power supply on a vehicle. The disclosed systems are arranged to charge the electric double-layer capacitor efficiently with regenerated electric power that is produced when the vehicle is decelerated, reduce electric noise when the electric power stored in the electric double-layer capacitor is discharged into the starter motor, and supply the electric power from the electric double-layer capacitor stably to other electric loads.

Japanese Laid-Open Patent Publication No. 6-261452 reveals a storage power supply apparatus having a plurality of series-connected cells as an electric double-layer capacitor, and a power supply monitoring circuit and a bypass circuit which are associated with each of the cells for eliminating stored power differences between the cells.

According to the disclosure of Japanese Laid-Open Patent Publication No. 8-339830, the service life of the lead storage battery can be extended if the average load current is small. However, the disclosed arrangement is not effective for loads that require a large current to be consumed, such as a starter motor for starting an engine.

The systems disclosed in Japanese Laid-Open Patent Publication No. 9-247856, Japanese Laid-Open Patent Publication No. 9-252546, Japanese Laid-Open Patent Publication No. 10-191576, and Japanese Laid-Open Patent Publication No. 6-261452 need a complex control means and a complex control process for individually controlling the lead storage battery and the electric double-layer capacitor.

On vehicles that incorporate control means for performing automatic engine idling stop, the lead storage battery needs to discharge and charge large electric currents through instantaneous current switching when the engine is restarted. Therefore, the lead storage battery operates under severe conditions. There have been demands in the art for means capable of increasing the service life of the lead storage battery under such severe conditions.

### SUMMARY OF THE INVENTION

It is an object of the present invention to provide a method of supplying an electric current, a method of starting an internal combustion engine, a power supply apparatus, and a vehicle which are capable of increasing the service life of a storage battery, with a simple and inexpensive arrangement and procedure.

A method of supplying an electric current according to the present invention comprises the steps of (a) discharging an electric current from a storage battery and an electric double-layer capacitor to an electric load, and (b) thereafter, automatically and instantaneously switching the current by changing a current flowing direction or by switching operation to charge the storage battery and the electric double-layer capacitor with an electric current from an electric generator, wherein the storage battery and the electric double-layer capacitor are connected in parallel to each other.

The electric double-layer capacitor has an electrostatic capacitance which is much greater than electrolytic capacitors. Consequently, by providing the storage battery and the electric double-layer capacitor in parallel to each other, the electric double-layer capacitor is capable of reliably taking up a large electric current when the lead storage battery is charged and discharged. If the electric double-layer capacitor is used in combination with a load for charging and discharging a large electric current with high frequency, the electric double-layer capacitor is effective in increasing the service life of the lead storage battery. Particularly, the service life of the lead storage battery is increased even under severe conditions in which a large electric current is instantaneously discharged into a starter motor or the like and immediately thereafter, a large electric current is charged from an electric generator.

The storage battery is a device which generates a chemical reaction with electric energy supplied from an external source, converts electric power produced from the chemical reaction into chemical energy, stores the chemical energy, and retrieves the stored chemical energy as an electromotive force when required.

The step (a) may comprise the step of actuating a starter generator, as the load, for starting an internal combustion engine on a vehicle, and the step (b) may comprise the step of charging the storage battery and the electric double-layer capacitor with electric power which is generated by the starter generator rotated by the internal combustion engine. Even under severe conditions in which instantaneous switching occurs between the charging of a large current and the discharging of a large current, as with a starter generator, the service life of the lead storage battery is increased. The storage battery may comprise a lead storage battery.

A method of starting an internal combustion engine on a vehicle according to the present invention comprises the steps of (a) discharging an electric current from a storage battery and an electric double-layer capacitor to a starter generator to actuate the starter generator for thereby starting the internal combustion engine on the vehicle, and

(b) thereafter, rotating the starter generator with the internal combustion engine which is started, to generate electric power to invert a current flowing direction, for thereby charging the storage battery and the electric double-layer capacitor, wherein the storage battery and the electric double-layer capacitor are connected in parallel to each other.

With the storage battery and the electric double-layer capacitor being connected in parallel to each other, the service life of the lead storage battery is increased when the internal combustion engine is stopped and restarted highly frequently.

A power supply apparatus according to the present invention comprises a storage battery and an electric double-layer capacitor which are connected in parallel to each other, an electric load for being supplied with electric power which is discharged from the storage battery and the electric double-layer capacitor, an electric generator for charging the storage battery and the electric double-layer capacitor, and a connection switching device connected between the storage battery and the electric double-layer capacitor, and the electric load and the electric generator, wherein the connection switching device connects the storage battery and the electric double-layer capacitor to the electric load to supply electric power from the storage battery and the electric double-layer capacitor to the electric load under a predetermined condition, and thereafter charges the storage battery and the electric double-layer capacitor with electric power from the electric generator when the electric generator starts to generate electric power.

Because the storage battery and the electric double-layer capacitor are connected in parallel to each other, when electric power is supplied from the storage battery and the electric double-layer capacitor to the electric load and thereafter the storage battery and the electric double-layer capacitor are charged with an electric current produced by the electric generator, the electric double-layer capacitor takes up a large electric current when the lead storage battery is charged and discharged. Therefore, the service life of the lead storage battery is increased.

The electric load may comprise a starter motor for starting an internal combustion engine, and the electric generator may generate electric power by being rotated by the internal combustion engine. The storage battery may comprise a lead storage battery.

If a line length between the electric double-layer capacitor and the electric load is shorter than a line length between the storage battery and the electric load, then a large amount of the electric current generated by the electric generator flows into the electric double-layer capacitor when it is charged. Accordingly, the service life of the lead storage battery is further increased.

A capacity ratio defined by dividing the capacity of the storage battery by the capacity of the electric double-layer capacitor may be in the range from 15 to 800. A resistance ratio defined by dividing the internal resistance of the storage battery by the internal resistance of the electric double-layer capacitor may be in the range from 0.1 to 10.

The capacity (Wh) of the lead storage battery is represented by the average voltage×the nominal capacity, and the capacity (Wh) of the electric double-layer capacitor by (1/2×C×the square of the maximum voltage−1/2×C×the square of the minimum voltage)/3600 where C represents the capacitance. The internal resistance (mΩ) of the lead storage battery is determined from the difference between a voltage which the lead storage battery has when it is discharged with 3C₃A (three times an electric current that flows when the lead storage battery is fully discharged for 3 hours) and a voltage which the lead storage battery has when it is discharged with 1C₃A (an electric current that flows when the lead storage battery is fully discharged for 3 hours). The internal resistance (mΩ) of the electric double-layer capacitor is defined as a voltage drop/current value at the time it is discharged with a predetermined electric current. Details are defined according to Standards of Electronic Industries Association of Japan EIAJRC-2377.

If the electric double-layer capacitor comprises a series-connected array of cells, then the cells may have capacity differences in the range of ±5% of the average capacity of the cells, and the cells may have self-discharged extent differences in the range of ±3% of the average self-discharged extent of the cells. The electric double-layer capacitor thus arranged is effective to prevent only certain cells from suffering an excessively high voltage when it is charged and discharged.

A power supply apparatus according to the present invention comprises an internal combustion engine for producing propulsive forces, a lead storage battery and an electric double-layer capacitor which are connected in parallel to each other, a starter motor for starting the internal combustion engine with electric power supplied thereto which is discharged from the storage battery and the electric double-layer capacitor, an electric generator for being rotated by the internal combustion engine to generate electric power for charging the storage battery and the electric double-layer capacitor, a connection switching device connected between the storage battery and the electric double-layer capacitor, and the electric load and the electric generator, and a controller for controlling a connected state of the connection switching device, the controller comprising idling stop means for stopping the internal combustion engine under a predetermined idling stop condition, and restarting means for instructing the connection switching device to supply electric power from the storage battery and the electric double-layer capacitor to the starter motor under a predetermined restarting condition, wherein when the restarting means judges that the predetermined restarting condition is satisfied, the connection switching device connects the storage battery and the electric double-layer capacitor to the starter motor to supply electric power which is discharged from the storage battery and the electric double-layer capacitor to the starter motor to start the internal combustion engine, and thereafter charges the storage battery and the electric double-layer capacitor with electric power from the electric generator when the electric generator starts to generate electric power.

Since the electric double-layer capacitor and the storage battery are connected in parallel to each other, when they discharge a large electric current to the starter motor and are charged with a large electric current from the electric generator highly frequently according to an engine idling stop function of a vehicle, the electric double-layer capacitor takes up a large electric current when the lead storage battery is charged and discharged. Therefore, the service life of the lead storage battery is increased.

The power supply apparatus may preferably be incorporated in a vehicle.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a block diagram of a power supply apparatus and a vehicle according to an embodiment of the present invention;

FIG. 2 is a perspective view of a cell of an electric double-layer capacitor;

FIG. 3 is a flowchart of a processing sequence for a method of supplying an electric current and a method of starting an internal combustion engine using the power supply apparatus;

FIG. 4 is a graph showing electric current conditions per cycle in a test;

FIG. 5 is a graph showing electric current curves of a lead storage battery and an electric double-layer capacitor per cycle in a test; and

FIG. 6 is a graph showing the results of an endurance test.

### DESCRIPTION OF THE PREFERRED EMBODIMENT

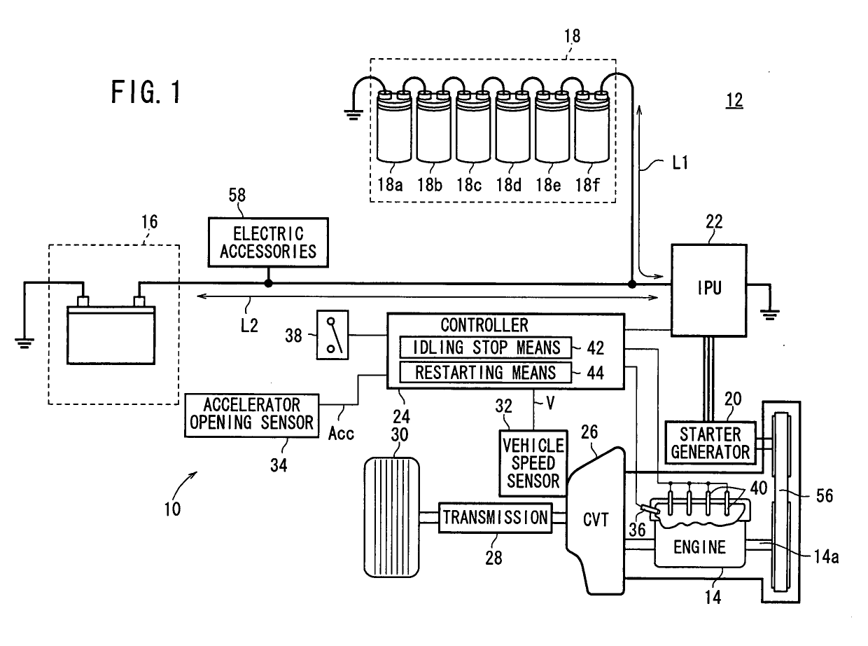

A method of supplying an electric current, a method of starting an internal combustion engine, a power supply apparatus, and a vehicle according to an embodiment of the present invention will be described below with reference to FIGS. 1 through 6. As shown in FIG. 1, a power supply apparatus 10 according to the embodiment of the present invention is mounted on a vehicle 12 for supplying electric power to electric accessories on the vehicle 12 and starting an engine on the vehicle 12.

As shown in FIG. 1, the vehicle 12 has an engine (internal combustion engine) 14 for producing propulsive forces, a lead storage battery 16 and an electric double-layer capacitor 18 which are connected in parallel to each other, a three-phase starter generator 20 for starting the engine 14 with electric power supplied from the lead storage battery 16 and the electric double-layer capacitor 18 and also for operating as an electric generator after the engine 14 has been started, an IPU (Intelligent Power Unit, connection switching device) 22 connected between the lead storage battery 16 and the electric double-layer capacitor 18, and the starter generator 20, and a controller 24 for controlling operation of the IPU 22.

The lead storage battery 16, the electric double-layer capacitor 18, the starter generator 20, the IPU 22, and the controller 24 jointly make up the power supply apparatus 10 on the vehicle 12.

The engine 14 produces rotational drive power. The produced rotational drive power is transmitted through a clutch mechanism, not shown, to a CVT (Continuously Variable Transmission) 26. The rotational drive power is transmitted at a speed reduction ratio from the CVT 26 to a transmission 28, from which the rotational drive power is transmitted at another speed reduction ratio to a drive wheel 30. The CVT 26 has an output shaft associated with a vehicle speed sensor 32, which sends a detected vehicle speed V to the controller 24.

To the controller 24, there are connected an accelerator opening sensor 34 for detecting an accelerator movement amount Acc and a brake pedal switch 38 for detecting when the brake pedal is depressed. The controller 24 is connected to injectors 36 and spark ignition plugs 40 for controlling an amount of fuel to be injected into the engine 14, controlling fuel injection timing, starting and stopping igniting an air-fuel mixture in the engine 14, and also controlling fuel ignition timing. The controller 24 has an idling stop means 42 for stopping operation of the engine 14 under predetermined idling stop conditions, and a restarting means 44 for instructing the IPU 22 under predetermined restarting conditions to supply electric power from the lead storage battery 16 and the electric double-layer capacitor 18 to the starter generator 20. The controller 24 comprises a CPU (Central Processing Unit) as a main control unit, a RAM (Random Access Memory) and a ROM (Read Only Memory) as a storage unit, a driver, etc. The functions of the controller 24 are performed when the CPU reads a program from the storage unit and executes the program in cooperation with the storage unit, etc.

The lead storage battery 16 is of a type for use as a power supply on general vehicles. The lead storage battery 16 is a device which generates a chemical reaction with electric energy supplied from an external source, converts electric power produced from the chemical reaction into chemical energy, stores the chemical energy, and retrieves the stored chemical energy as an electromotive force when required.

The electric double-layer capacitor 18 is an electric power storage device for storing electric power using an electric double layer that is generated in the interface between activated carbon and electrolytic solution. The electric double-layer capacitor 18 does not have a dielectric body used in electrolytic capacitors and does not produce a chemical reaction caused in the lead storage battery 16. Though the electric double-layer capacitor 18 is of a small size, it has an electrostatic capacitance in farads (F), and does not require a special charging circuit. Furthermore, the electric double-layer capacitor 18 has its service life unaffected by charging cycles and overdischarging cycles.

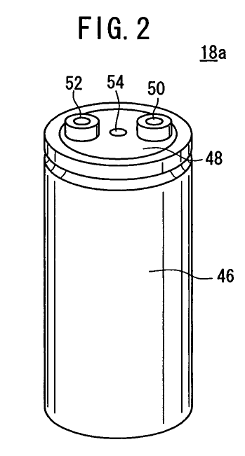

The electric double-layer capacitor 18 comprises a series-connected array of six cells 18a, 18b, 18c, 18d, 18e, 18f. As shown in FIG. 2, the cell 18a is of a cylindrical shape, and has an electrically conductive, bottomed hollow cylindrical casing 46 and an insulating terminal plate 48 closing an open end of the hollow cylindrical casing 46. A positive terminal 50, a negative terminal 52, and a safety valve 54 are mounted on the terminal plate 48. The hollow cylindrical casing 46 is made of an aluminum alloy, for example, and the terminal plate 48 is made of synthetic resin, for example. The hollow cylindrical casing 46 houses therein an electrode coil assembly comprising a web-shaped positive electrode and a web-shaped negative electrode which are spirally wound in layers with an electrolyte-impregnated separator interposed therebetween. The other cells 18b through 18f are identical in structure to the cell 18a.

As shown in FIG. 1, the starter generator 20 is a so-called ISG (Integrated Starter Generator), and functions as both a starter motor (electric load) and an alternator (electric generator). Specifically, when electric power supplied from the lead storage battery 16 and the electric double-layer capacitor 18 is converted into three-phase electric power by the IPU 22 and supplied to the starter generator 20, the starter generator 20 operates as a starter motor and rotates a crankshaft 14a through a belt system 56 to start the engine 14. After the engine 14 has started to operate, the starter generator 20 is rotated by the engine 14 to generate electric power, which is supplied through the IPU 22 to charge the lead storage battery 16 and the electric double-layer capacitor 18. The starter generator 20 thus arranged is capable of smoothly stopping the engine 14 from idling and regenerating electric power when the vehicle 12 is braked. The belt system 56 may be combined with an automatic tensioner with a lock mechanism for adjusting the belt tension to an appropriate initial tension level when the belt system 56 is in operation.

The IPU 22 is controlled by the controller 24 for selectively connecting the lead storage battery 16 and the electric double-layer capacitor 18 to and disconnecting the lead storage battery 16 and the electric double-layer capacitor 18 from the starter generator 20. When the IPU 22 connects the lead storage battery 16 and the electric double-layer capacitor 18 to the starter generator 20, the IPU 22 can convert DC electric power from the lead storage battery 16 and the electric double-layer capacitor 18 into three-phase AC electric power and supply the three-phase AC electric power to the starter generator 20, and can also convert three-phase AC electric power from the starter generator 20 into DC electric power and charge the lead storage battery 16 and the electric double-layer capacitor 18 with the DC electric power.

The lead storage battery 16, the electric double-layer capacitor 18, the starter generator 20, the IPU 22, and the controller 24 of the power supply apparatus 10 are mounted in the engine compartment, for example, of the vehicle 12. The lead storage battery 16 and the electric double-layer capacitor 18 are positioned such that the line length L1 between the electric double-layer capacitor 18 and the starter generator 20 is shorter than the line length L2 between the lead storage battery 16 and the starter generator 20. The line interconnecting the lead storage battery 16 and the IPU 22 is branched into a line that is connected to electric accessories 58 through a fuse box, not shown. The electric accessories 58 include general vehicular accessories such as headlights, an audio system, etc.

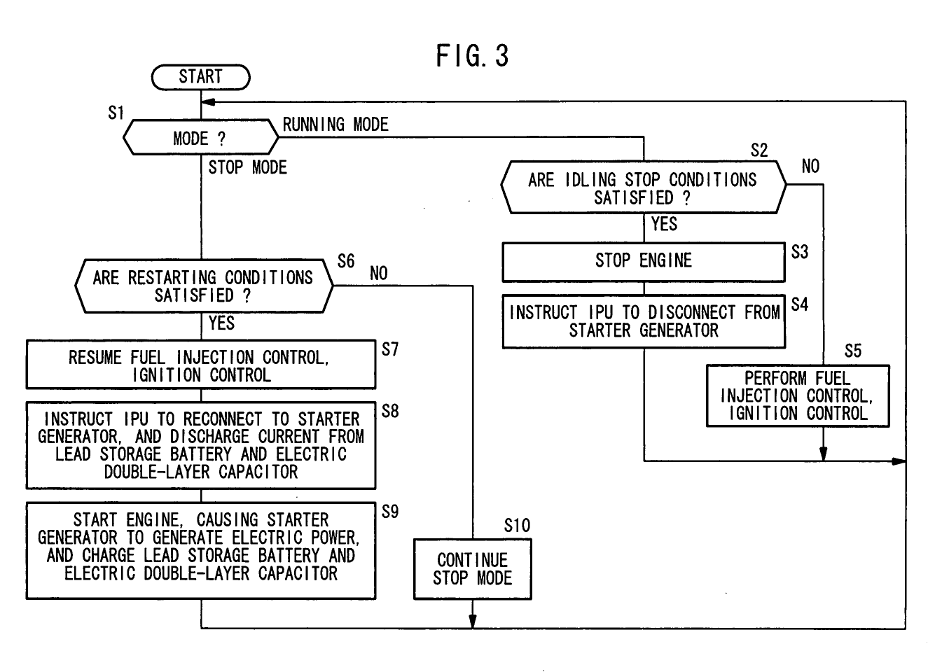

A method of supplying an electric current and a method of starting the engine 14, which are carried out by the power supply apparatus 10 constructed as described above, will be described below with reference to a processing sequence shown in FIG. 3. The processing sequence shown in FIG. 3 is performed mainly by the controller 24 and the IPU 22 in cooperation with each other.

In step S1 shown in FIG. 3, it is determined whether the vehicle 12 is in a running mode or a stop mode. If the vehicle 12 is in the running mode, then control goes to step S2. If the vehicle 12 is in the stop mode, then control goes to step S6.

In step S2 (running mode), the idling stop means 42 determines whether idling stop conditions are satisfied or not. The idling stop conditions are judged based on output signals from the vehicle speed sensor 32, the accelerator opening sensor 34, the brake pedal switch 38, for example. Specifically, the idling stop conditions are judged as being satisfied if the brake pedal has been depressed, accelerator movement amount Acc is nil, and the vehicle speed V is nil for a given period of time. If the idling stop conditions are satisfied, then control goes to step S3. If the idling stop conditions are not satisfied, then control goes to step S5. Since the discharging ability of the lead storage battery 16 varies depending on the temperature, the lead storage battery 16 may be associated with a temperature sensor, the controller 24 may monitor a temperature signal from the temperature sensor, and a condition based on the temperature signal may be added to the idling stop conditions.

In step S3, the fuel injection from the injectors 36 is stopped, and the spark ignition by the spark ignition plugs 40 is stopped, thereby stopping the engine 14. Therefore, while the engine 14 stops idling, the engine 14 does not emit exhaust gases, and hence the emission performance is increased. In step S3, the vehicle 12 changes from the running mode to the stop mode.

In step S4, the controller 24 gives a command signal to the IPU 22 to disconnect the lead storage battery 16 and the electric double-layer capacitor 18 from the starter generator 20.

In step S5, the controller 24 controls the injectors 36 to inject the fuel into the engine 14 and also controls the spark ignition plugs 40 to ignite the fuel in the engine 14 as normal running control.

In step S6 (stop mode), the restarting means 44 determines whether restarting conditions are satisfied or not. The restarting conditions are judged based on output signals from the accelerator opening sensor 34 and the brake pedal switch 38, for example. Specifically, the restarting conditions are judged as being satisfied if the accelerator pedal is detected as being operated and the brake pedal is released. If the restarting conditions are satisfied, then control goes to step S7. If the restarting conditions are not satisfied, then control goes to step S10 to perform a certain process to continue the stop mode.

In step S7, the controller 24 resumes its process of controlling the injectors 36 to inject the fuel into the engine 14 and also controlling the spark ignition plugs 40 to ignite the fuel in the engine 14, and the engine 14 changes from the stop mode to the running mode.

In step S8, the controller 24 gives a command signal to the IPU 22 to reconnect the lead storage battery 16 and the electric double-layer capacitor 18 to the starter generator 20, discharging the electric power from the lead storage battery 16 and the electric double-layer capacitor 18 to the starter generator 20, thereby rotating the starter generator 20. Since the starter generator 20 has been stopped, a very large electric current flows through the starter generator 20, which is a characteristic of a rotating electrical machine that has stopped.

When the starter generator 20 is thus supplied with the electric power, the starter generator 20 is rotated to rotate the crankshaft 14a through the belt system 56 to start the engine 14.

In step S9, the engine 14 is started and, within a certain period of time, the rotational drive power of the crankshaft 14a becomes greater than the rotational drive power of the starter generator 20. The starter generator 20 is now rotated by the rotational drive power from the crankshaft 14a, whereupon the starter generator 20 switches from the starter motor to the alternator, beginning to generate electric power. At this time, the IPU 22 is controlled by the controller 24 to automatically change the direction to pass an electric current by way of switching or other means, converting AC electric power generated by the starter generator 20 into DC electric power and supplying the DC electric power to charge the lead storage battery 16 and the electric double-layer capacitor 18.

The instant immediately after the engine 14 has started, the crankshaft 14a of the engine 14 rotates considerably fast at a speed high enough to reliably operate the engine 14, and, therefore, the starter generator 20 generates and supplies a large amount of electric power to the lead storage battery 16 and the electric double-layer capacitor 18. That is, when the engine 14 is started, the lead storage battery 16 and the electric double-layer capacitor 18 are charged with a large electric current, and the direction in which the electric current passes through the lead storage battery 16 and the electric double-layer capacitor 18 is automatically and instantaneously changed. Such a large electric current and automatic and instantaneous changing of the direction of the electric current pose severe conditions on the lead storage battery 16 which is charged and discharged based on the chemical reaction.

The lead storage battery 16 and the electric double-layer capacitor 18 are connected in parallel to each other. The electric double-layer capacitor 18 has an electrostatic capacitance which is much greater than electrolytic capacitors. Consequently, the electric double-layer capacitor 18 is capable of reliably taking up a large electric current when the lead storage battery 16 is charged and discharged. The service life of the lead storage battery 16 is thus prevented from being unduly shortened.

Inasmuch as the line length L1 between the electric double-layer capacitor 18 and the starter generator 20 is shorter than the line length L2 between the lead storage battery 16 and the starter generator 20, the line resistance between the electric double-layer capacitor 18 and the starter generator 20 is smaller than the line resistance between the lead storage battery 16 and the starter generator 20. Therefore, a considerable amount of electric current flows toward the electric double-layer capacitor 18 for thereby further increasing the service life of the lead storage battery 16.

Even if the lead storage battery 16 and the electric double-layer capacitor 18 discharge a large electric current, since they are charged with a large electric current immediately after they are discharged, the lead storage battery 16 and the electric double-layer capacitor 18 remain sufficiently charged at all times. Therefore, the engine 14 can reliably be started with the electric power supplied from the lead storage battery 16 and the electric double-layer capacitor 18 even when the engine 14 needs to be frequently started according to the engine idling stop process.

After steps S4, S5, S9, and S10, control goes back to step S1 to repeat the processing sequence shown in FIG. 3.

As described above, the electric double-layer capacitor 18 connected in parallel to the lead storage battery 16 is effective in increasing the service life of the lead storage battery 16. To confirm the effectiveness of the electric double-layer capacitor 18 to make the service life of the lead storage battery 16 longer, the inventors conducted the following experiment.

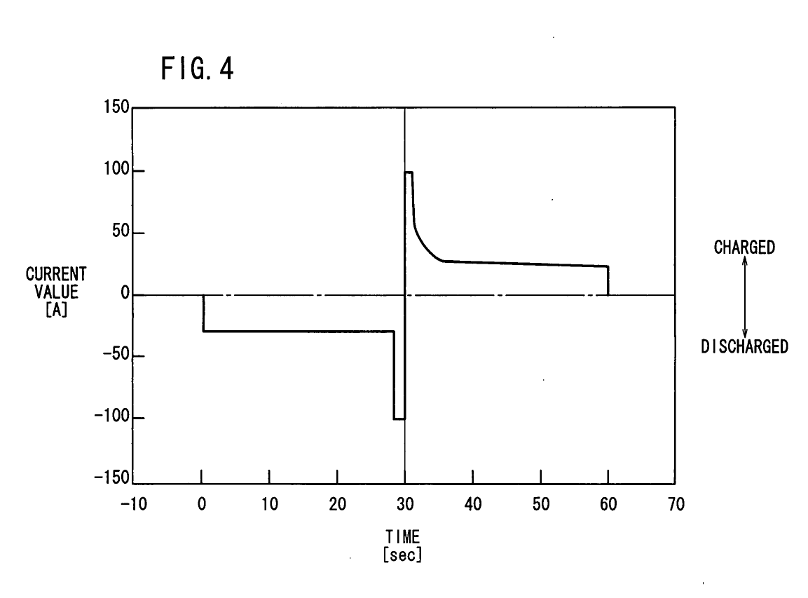

In the experiment, a current condition shown in FIG. 4 was established to provide electric currents that are substantially equivalent to those on actual vehicles. Specifically, one cycle of operation has a period of 70 seconds. From the start of the cycle up to 29 seconds, an electric current of 30 A is discharged, and from 29 seconds to 30 seconds, an electric current of 100 A is discharged. For one second from 30 seconds to 31 seconds, an electric current of 100 A is charged. From 31 seconds, an electric current is charged from a given power supply so that the charged amount is reduced in inverse proportion to the time until 60 seconds whereupon an electric current of about 30 A is charged. For 10 seconds from 60 seconds to 70 seconds, no electric current is charged and discharged. An endurance test was conducted in a plurality of cycles each under the above current condition.

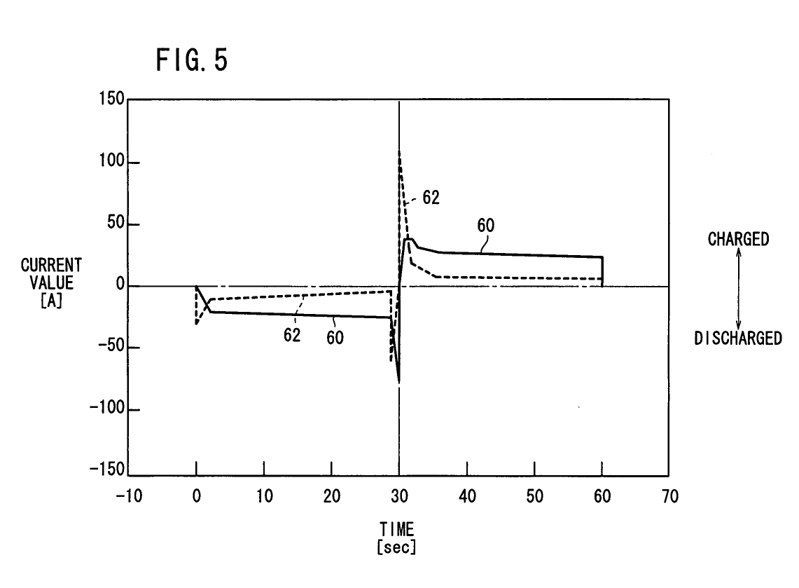

In the endurance test, the lead storage battery 16 and the electric double-layer capacitor 18 were charged and discharged according to individual curves 60, 62, respectively, shown in FIG. 5. Specifically, according to the curve 60 for the lead storage battery 16, an electric current discharged from the lead storage battery 16 increases in proportion to the time from the start of the cycle to 20 A until 29 seconds. From 29 seconds, the electric current discharged from the lead storage battery 16 sharply increases to about 80 A at 30 seconds. Thereafter, an electric current is charged into the lead storage battery 16. From 31 seconds to 32 seconds, an electric current of about 40 A is charged into the lead storage battery 16. From 32 seconds, the electric current charged into the lead storage battery 16 gradually decreases until 60 seconds whereupon an electric current of 25 A is charged into the lead storage battery 16.

According to the curve 62 for the electric double-layer capacitor 18, an electric current of 30 A is discharged from the electric double-layer capacitor 18 immediately after the start of the cycle. The discharged electric current then decreases to about 10 A, and remains at this level until 29 seconds whereupon a peaky electric current of about 75 A is discharged from the electric double-layer capacitor 18. Immediately thereafter at 30 seconds, the electric double-layer capacitor 18 is charged with an electric current at a peak of 110 A. From 30 seconds, the electric current charged into the lead storage battery 16 decreases in inverse proportion to the time until 40 seconds whereupon the electric double-layer capacitor 18 is charged with an electric current of about 5 A. The electric double-layer capacitor 18 keeps being charged with the electric current of about 5 A until 60 seconds.

The curve 60 shown in FIG. 5 indicates that the electric current charged into and discharged from the lead storage battery 16 is considerably smaller than the peak current of 100 A according to the current condition shown in FIG. 4. Therefore, it is understood that the electric double-layer capacitor 18 takes up a relatively large amount of current that is supplied to and from the starter generator 20. The sum of the charged and discharged electric currents represented by the curves 60, 62 is equal to the charged and discharged electric currents according to the current condition shown in FIG. 4.

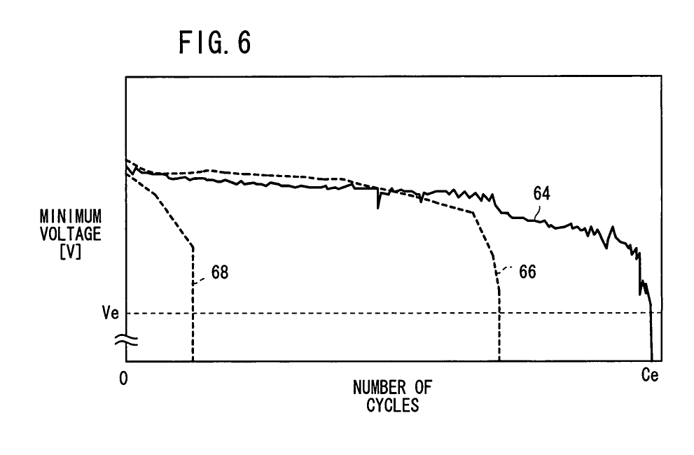

The results of the endurance test are shown in FIG. 6. In FIG. 6, the horizontal axis represents the number of cycles, i.e., the cycle count, and the vertical axis the minimum voltage provided by the lead storage battery 16 and/or the electric double-layer capacitor 18 in each cycle. The endurance test ended when the minimum voltage became lower than a predetermined voltage Ve.

A curve 64 represents the test result achieved by the parallel-connected assembly of the lead storage battery 16 and the electric double-layer capacitor 18. The curve 64 shows that the minimum voltage gradually decreases as the number of cycles increases, but remains at a practically sufficient level immediately prior to a cycle count Ce at the end of the test.

A curve 66 represents the test result achieved by a comparative example in which a lead storage battery having a rated capacity (Ah) which is 1.7 times more than that of the lead storage battery 16 and in which the electric double-layer capacitor 18 was not used. The curve 66 is essentially similar to the curve 66 up to a cycle count that is half the cycle count Ce. After the cycle count that is half the cycle count Ce, the curve 64 sharply drops, and the cycle count at the end of the test is about 0.7 times the cycle count Ce.

A curve 68 represents the test result achieved by another comparative example in which an electrolytic capacitor (114 μF), instead of the electric double-layer capacitor 18, was connected in parallel to the lead storage battery 16. According to the curve 68, the voltage drops relatively sharply after the start of the test, and cycle count at the end of the test is about 0.15 times the cycle count Ce. Though not shown, the test result achieved by still another comparative example in which only the lead storage battery 16 was used is not essentially different from the test result indicated by the curve 68. Therefore, no appreciable advantages are produced by connecting an electrolytic capacitor in parallel to the lead storage battery 16.

As described above, it has been confirmed that the parallel-connected assembly of the lead storage battery 16 and the electric double-layer capacitor 18 for the vehicle 12 and the power supply apparatus 10 is effective to allow the lead storage battery 16 to have a longer service life than if an electrolytic capacitor is connected in parallel to the lead storage battery 16, and to have a longer service life than other lead storage batteries having a rated capacity that is 1.7 times the lead storage battery 16. It has also been confirmed that the parallel-connected assembly of the lead storage battery 16 and the electric double-layer capacitor 18 is suitable for use in the vehicle 12 with the engine idling stop mechanism where the engine 14 is required to start frequently.

In the parallel-connected assembly, only the lead storage battery 16 is used up, and the electric double-layer capacitor 18 can be reused. The electric double-layer capacitor 18 stores electric energy by physically adsorbing and desorbing ions, and has nothing chemically deteriorated by being charged and discharged.

The inventors conducted various confirmative tests for setting detailed conditions for the electric double-layer capacitor 18 to allow the lead storage battery 16 combined therewith to have a longer service life. According to the results of the confirmative tests, a capacity ratio “a” which is defined by dividing the capacity of the lead storage battery 16 by the capacity of the electric double-layer capacitor 18, i.e., the sum of the capacities of the series-connected cells 18a through 18f, should be in the range of 15≦a≦800. The capacity (Wh) of the lead storage battery 16 is represented by the average voltage×the nominal capacity, and the capacity (Wh) of the electric double-layer capacitor 18 by (1/2×C×the square of the maximum voltage−1/2×C×the square of the minimum voltage)/3600 where C represents the capacitance.

A resistance ratio “b” which is defined by dividing the internal resistance of the lead storage battery 16 by the internal resistance of the electric double-layer capacitor 18, i.e., the sum of the internal resistances of the series-connected cells 18a through 18f, should be in the range of 0.1≦b≦10. The internal resistance (mΩ) of the lead storage battery 16 is determined from the difference between a voltage which the lead storage battery 16 has when it is discharged with 3C₃A (three times an electric current that flows when the lead storage battery 16 is fully discharged for 3 hours) and a voltage which the lead storage battery 16 has when it is discharged with 1C₃A (an electric current that flows when the lead storage battery 16 is fully discharged for 3 hours). The internal resistance (mΩ) of the electric double-layer capacitor 18 is defined as a voltage drop/current value at the time it is discharged with a predetermined electric current. Details are defined according to Standards of Electronic Industries Association of Japan EIAJRC-2377. With the resistance ratio “b” being thus defined, well-balanced electric currents flow to and from the lead storage battery 16 and the electric double-layer capacitor 18 when they are charged and discharged, preventing an excessively large electric current from flowing to and from only either one of the lead storage battery 16 and the electric double-layer capacitor 18.

Since the electric double-layer capacitor 18 is made up of the series-connected cells 18a through 18f, the same current flows through each of the cells 18a through 18f. However, the cells 18a through 18f have different charged voltages when they are charged and discharged because their capacities are no necessarily the same. Specifically, when the electric double-layer capacitor 18 is charged, those cells which have smaller capacities than the average capacity have relatively high charged voltages, and those cells which have greater capacities than the average capacity have relatively low charged voltages. Each of the cells 18a through 18f has a predetermined rated voltage, and should not have an excessively high voltage on account of capacity differences because such an excessively high voltage is liable to shorten the service life thereof.

If the capacity differences between the cells 18a through 18f are in range of ±5% of the average capacity of the cells 18a through 18f, then the electric double-layer capacitor 18 is effective to prevent only certain cells from suffering an excessively high voltage when it is charged and discharged.

The cells 18a through 18f are not self-discharged under equal conditions. Consequently, when not in use, the cells 18a through 18f tend to have different charged voltages when they are self-discharged and develop voltage drops. Specifically, those cells which are self-discharged to a less extent are liable to have a relatively small charged voltage drop, and those cells which are self-discharged to a greater extent are liable to have a relatively large charged voltage drop. When those cells which have a relatively small charged voltage drop are charged again, their charged voltages tend to become excessively high, reducing their service life.

If the self-discharged extent differences between the cells 18a through 18f are in range of ±3% of the average self-discharged extent of the cells 18a through 18f, then the self-discharge extent differences are suppressed sufficiently, and the electric double-layer capacitor 18 is effective to prevent only certain cells from suffering an excessively high voltage when it is charged and discharged.

If the capacity differences and the self-discharged extent differences between the cells 18a through 18f are in the range of ±5% of the average capacity and the range of ±3% of the average self-discharged extent, then the electric double-layer capacitor 18 is effective to keep their charged voltages essentially uniform. As a result, the power supply apparatus 10 does not require the power supply monitoring circuit and the bypass circuit for each of the cells and the control means for controlling them, as disclosed in Japanese Laid-Open Patent Publication No. 6-261452, and is relatively simple in structure and inexpensive to manufacture as it basically only needs electrically conductive lines.

According to the method of supplying an electric current using the vehicle 12 and the power supply apparatus 10 and the method of starting an internal combustion engine as described above, the electric double-layer capacitor 18 is connected in parallel to the lead storage battery 16 to take up a large electric current when the lead storage battery 16 is charged and discharged. The service life of the lead storage battery 16 is thus increased even under severe conditions in which a large electric current is instantaneously discharged and immediately thereafter a large electric current is charged, as with the starter generator 20 connected as a load. Inasmuch as the lead storage battery 16 and the electric double-layer capacitor 18 are connected in parallel to each other, the power supply apparatus 10 does not need a complex control means and a complex control process for selecting different current lines, and hence is simple in structure and inexpensive to manufacture.

Hybrid vehicles that have been recently developed and put into practical use have an engine and an electric motor as propulsive drive sources. Since the engine on such hybrid vehicles is started and stopped highly frequently depending on how the hybrid vehicle runs, the storage battery for supplying electric power to start the engine is likely to have its service life reduced. If the power supply apparatus 10 according to the present invention is incorporated in a hybrid vehicle, then the storage battery on the hybrid vehicle can have its service life increased.

The power supply apparatus 10 can also be used on vehicles free of an automatic engine idling stop mechanism if their engines are required to be started and stopped frequently, e.g., vehicles used for delivery services. The load on the power supply apparatus 10 is not limited to the starter generator 20, but may be any loads through which a large instantaneous electric current flows, e.g., a lock mechanism for an automatic slide door on vehicles.

The power supply apparatus 10 is not limited to being used on vehicles, but may be used as a stationary power supply apparatus. The lead storage battery 16 may be replaced with another storage battery depending on the application.

Although a certain preferred embodiment of the present invention has been shown and described in detail, it should be understood that various changes and modifications may be made therein without departing from the scope of the appended claims.

What is claimed is:

1. A method of supplying an electric current, comprising the steps of:
(a) discharging an electric current from a storage battery and an electric double-layer capacitor to an electric load; and
(b) thereafter, automatically and instantaneously switching the current by changing a current flowing direction or by switching operation to charge the storage battery and the electric double-layer capacitor with an electric current from an electric generator;
wherein said storage battery and said electric double-layer capacitor are connected in parallel to each other.

2. A method according to claim 1, wherein said step (a) comprises the step of actuating a starter generator, as said load, for starting an internal combustion engine on a vehicle, and said step (b) comprises the step of charging said storage battery and said electric double-layer capacitor with electric power which is generated by said starter generator rotated by said internal combustion engine.

3. A method according to claim 2, wherein said storage battery comprises a lead storage battery.

4. A method of starting an internal combustion engine on a vehicle, comprising the steps of:
(a) discharging an electric current from a storage battery and an electric double-layer capacitor to a starter generator to actuate said starter generator for thereby starting said internal combustion engine on said vehicle; and
(b) thereafter, rotating said starter generator with said internal combustion engine which is started, to generate electric power to invert a current flowing direction, for thereby charging said storage battery and said electric double-layer capacitor;
wherein said storage battery and said electric double-layer capacitor are connected in parallel to each other.

5. A power supply apparatus comprising:
a storage battery and an electric double-layer capacitor which are connected in parallel to each other;
an electric load for being supplied with electric power which is discharged from said storage battery and said electric double-layer capacitor;
an electric generator for charging said storage battery and said electric double-layer capacitor; and
a connection switching device connected between said storage battery and said electric double-layer capacitor, and said electric load and said electric generator;
wherein said connection switching device connects said storage battery and said electric double-layer capacitor to said electric load to supply electric power from said storage battery and said electric double-layer capacitor to said electric load, and thereafter charges said storage battery and said electric double-layer capacitor with electric power from said electric generator when said electric generator starts to generate electric power.

6. A power supply apparatus according to claim 5, wherein said electric load comprises a starter motor for starting an internal combustion engine, and said electric generator generates electric power by being rotated by said internal combustion engine.

7. A power supply apparatus according to claim 6, wherein said storage battery comprises a lead storage battery.

8. A power supply apparatus according to claim 5, wherein a line length between said electric double-layer capacitor and said electric load is shorter than a line length between said storage battery and said electric load.

9. A power supply apparatus according to claim 5, wherein a capacity ratio defined by dividing the capacity of said storage battery by the capacity of said electric double-layer capacitor is in the range from 15 to 800.

10. A power supply apparatus according to claim 5, wherein a resistance ratio defined by dividing the internal resistance of said storage battery by the internal resistance of said electric double-layer capacitor is in the range from 0.1 to 10.

11. A power supply apparatus according to claim 5, wherein said electric double-layer capacitor comprises a series-connected array of cells, said cells having capacity differences in the range of ±5% of the average capacity of said cells.

12. A power supply apparatus according to claim 5, wherein said electric double-layer capacitor comprises a series-connected array of cells, said cells having self-discharged extent differences in the range of ±3% of the average self-discharged extent of said cells.

13. A power supply apparatus comprising:
an internal combustion engine for producing propulsive forces;
a lead storage battery and an electric double-layer capacitor which are connected in parallel to each other;
a starter motor for starting said internal combustion engine with electric power supplied thereto which is discharged from said storage battery and said electric double-layer capacitor;
an electric generator for being rotated by said internal combustion engine to generate electric power for charging said storage battery and said electric double-layer capacitor;
a connection switching device connected between said storage battery and said electric double-layer capacitor, and said electric load and said electric generator; and
a controller for controlling a connected state of said connection switching device;
said controller comprising:
idling stop means for stopping said internal combustion engine under a predetermined idling stop condition; and
restarting means for instructing said connection switching device to supply electric power from said storage battery and said electric double-layer capacitor to said starter motor under a predetermined restarting condition;
wherein when said restarting means judges that said predetermined restarting condition is satisfied, said connection switching device connects said storage battery and said electric double-layer capacitor to said starter motor to supply electric power which is discharged from said storage battery and said electric double-layer capacitor to said starter motor to start said internal combustion engine, and thereafter charges said storage battery and said electric double-layer capacitor with electric power from said electric generator when said electric generator starts to generate electric power.

14. A motor vehicle comprising a power supply apparatus according to claim 5.

15. A motor vehicle comprising a power supply apparatus according to claim 6.

16. A motor vehicle comprising a power supply apparatus according to claim 7.

17. A motor vehicle comprising a power supply apparatus according to claim 8.

18. A motor vehicle comprising a power supply apparatus according to claim 9.

19. A motor vehicle comprising a power supply apparatus according to claim 10.

20. A motor vehicle comprising a power supply apparatus according to claim 11.
